(19) United States
(12) Patent Application Publication
(10) Pub. No.: US 2007/0138939 A1
(43) Pub. Date: Jun. 21, 2007

(54) Electron emission display

(76) Inventor: Sung-Hwan Jin, Suwon-si (KR)

Correspondence Address: Robert E. Bushnell, Suite 300, 1522 K Street, N.W., Washington, DC, 20005, US

(21) Appl. No.: 11/591,500

(22) Filed: Nov. 2, 2006

(30) Foreign Application Priority Data
Nov. 2, 2005 (KR) 10-2005-0104211

(51) Int. Cl. H01J 63/04; H01J 19/42

(52) U.S. Cl. 313/495; 313/292

(57) ABSTRACT

Provided is an electron emission display. The electron emission display is constructed with first and second substrates facing each other and having pixel regions, electron emission regions formed on the first substrate, driving electrodes provided on the first substrate for controlling an electron emission of the electron emission regions, phosphor layers formed on a surface of the second substrate and spaced apart from each other, an anode electrode formed on a surface of the phosphor layer, and spacers disposed between the first and second substrates to correspond to a region between the phosphor layers. The electron emission display satisfies the following condition: 0.05<x/A≦0.4, where “x” is a distance between the spacer and the closest part of the emission region which is closest to the spacer in at least one pixel region adjacent to the spacer, and “A” is a distance between the spacer and a distal end of the phosphor layer from the spacer in the pixel region adjacent to the spacer.

### CLAIM OF PRIORITY

This application makes reference to, incorporates the same herein, and claims all benefits accruing under 35 U.S.C. §119 from an application for ELECTRON EMISSION DEVICE earlier filed in the Korean Intellectual Property Office on 2 Nov. 2005 and there duly assigned Serial No. 10-2005-0104211.

### BACKGROUND OF THE INVENTION

1. Field of the Invention

The present invention relates to an electron emission display, and more particularly, to an electron emission display that can suppress a distortion of an electron beam scan path, which is caused by an electric charge of a spacer, by improving an arrangement structure of an electron emission region and the spacer.

2. Description of the Related Art

Generally, electron emission elements arrayed on electron emission devices are classified into those using hot cathodes as an electron emission source, and those using cold cathodes as the electron emission source.

As the electron emission elements using cold cathodes, field emission array (FEA) elements, surface-conduction emission (SCE) elements, metal-insulator-metal (MIM) elements, and metal-insulator-semiconductor (MIS) elements are known.

The FEA electron emission element includes an electron emission region and cathode and gate electrodes functioning as driving electrodes for controlling electron emission from the electron emission regions, and uses a theory that electrons are effectively emitted by an electric field under a vacuum atmosphere from a material having a relatively low work function or a relatively large aspect ratio, e.g., a carbon-based material such as carbon nanotubes, graphite, and diamond-like carbon.

The electron emission elements are arrayed on a substrate to constitute an electron emission device. The electron emission device is combined with another substrate on which a light emission unit including a phosphor layer and an anode electrode are formed, thereby constituting an electron emission display.

In the electron emission display, the first substrate on which the electron emission regions and driving electrodes are provided and the second substrate on which the light emission unit are sealed together by a sealing member provided at the peripheries. The inner space defined by the first and second substrates and the sealing member is exhausted to form a vacuum envelope kept to a degree of vacuum of about 10⁻⁶ torr.

Due to the pressure difference between the interior and the exterior of the vacuum envelope, the vacuum envelope is subjected to high compression. The compression increases in proportion to the panel size. Accordingly, a technology for enduring the compression experienced by the vacuum envelope and thus uniformly maintaining a gap between the first and second substrates by disposing a plurality of spacers between the first and second substrates has been developed and used in contemporary designes. At this point, in order to prevent a short circuit between the driving electrode and the anode electrode, the spacers are mainly made from a dielectric material such as glass or ceramic and placed to correspond to a black layer so as not to interfere with the phosphor layer.

Even when a focusing electrode is provided, it is difficult, however, for most of the electron emission displays to obtain the perfect electron beam collimation. Therefore, when the electrons emitted from the electron emission region provided on the first substrate travel toward the second substrate, they are diffused at a diffusion angle. By this diffusion of the electron beams, the electrons collide with surfaces of the spacers and thus the spacers are charged with positive or negative potential depending upon the material properties thereof (such as a dielectric constant or a secondary electron emission coefficient).

The charged spacers alter the neighboring electric fields, thereby distorting the electron beam scan paths. For example, when the spacers are charged with a positive potential, the spacers attract, and thereby distort the electron beams. When the spacers are charged with a negative potential, the spacers repel, and thereby deflect the electron beams. The distortion or deflection of the electron beam scan paths obstructs accurate color production around the spacers and causes the spacers to visually appear on the screen, thereby deleteriously reducing the overall display quality.

### SUMMARY OF THE INVENTION

It is therefore an object of the present invention to provide an improved electron emission display.

It is another object to provide an electron emission display that suppresses the deterioration of the display quality, caused by the distortion of the electron beam scan path by the surface charging of spacers, by minimizing an amount of electrons colliding with surfaces of the spacers.

According to an embodiment of the present invention, an electron emission display is constructed with first and second substrates facing each other and having pixel regions, electron emission regions formed on the first substrate, driving electrodes provided on the first substrate for controlling an electron emission of the electron emission regions, phosphor layers formed on a surface of the second substrate and spaced apart from each other, an anode electrode formed on a surface of the phosphor layer, and spacers disposed between the first and second substrates to correspond to a region between the phosphor layers. The electron emission display satisfies the following condition:
0.05<x/A≦0.4 (1)
where “x” is a distance between the spacer and the closest part of the electron emission region closest to the spacer in at least one pixel region adjacent to the spacer, and “A” is a distance between the spacer and the farthest end of the phosphor layer from the spacer in the pixel region adjacent to the spacer.

According to another embodiment of the present invention, an electron emission display is constructed with first and second substrates facing each other and having pixel regions, electron emission regions formed on the first substrate, driving electrodes provided on the first substrate for controlling an electron emission of the electron emission regions, phosphor layers formed on a surface of the second substrate and spaced apart from each other, an anode electrode formed on a surface of the phosphor layer, and spacers disposed between the first and second substrates to correspond to a region defined between the phosphor layers. The electron emission display satisfies the following condition:
X>Y•tan θ(θ<10°) (2)
where, “x” is a distance between the spacer and the outermost electron emission region closest to the spacer in the pixel region adjacent to the spacer, “θ” is an electron beam diffusion angle, and “Y” is a distance between the first and second substrates.

In the above two embodiments, when a portion of the pixel region at which the electron emission regions are provided to emit electrons, is defined as an effective electron emission region, the distance “x” between the spacer and the outermost electron emission region may be replaced with a distance “x′” between the spacer and the effective electron emission region in at least one pixel region adjacent to the spacer.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial exploded oblique view of an electron emission display constructed as an embodiment of the principles of the present invention;

FIG. 2 is a partial cross-sectional view of the electron emission display of FIG. 1;

FIG. 3 is a partial top view of a first substrate structure of the electron emission display of FIG. 1;

FIG. 4 is a partial top view illustrating an arrangement for a second substrate structure of the electron emission display of FIG. 1;

FIG. 5 is a photograph illustrating a light emission pattern of a phosphor layer in an electron emission display of a comparative example;

FIG. 6 is a partial top view of the first substrate structure of the electron emission display of FIG. 1; and

FIG. 7 is a partial cross-sectional view of the electron emission display of FIG. 1.

### DETAILED DESCRIPTION OF INVENTION

The present invention is described more fully below with reference to the accompanying drawings, in which exemplary embodiments of the present invention are shown. The present invention can, however, be embodied in many different forms and should not be construed as being limited to the embodiments set forth herein; rather these embodiments are provided so that this disclosure will be thorough and complete, and will fully convey the concept of the present invention to those skilled in the art. Wherever possible, the same reference numbers are used throughout the drawings to refer to the same or like parts.

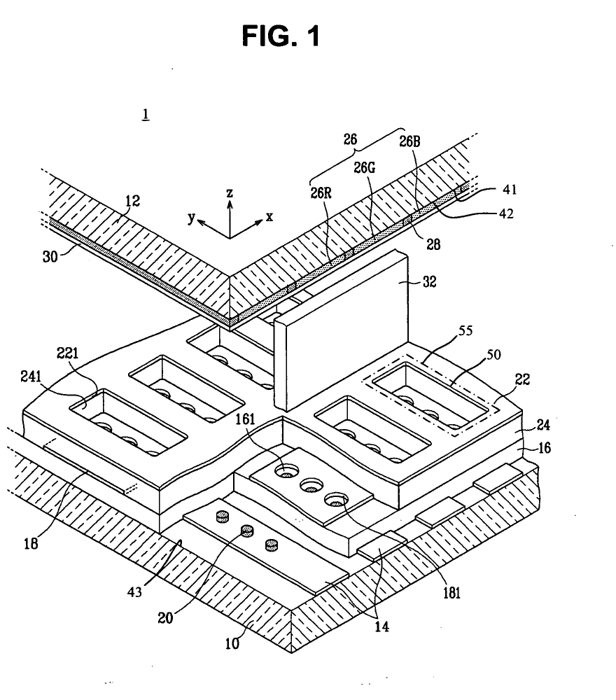

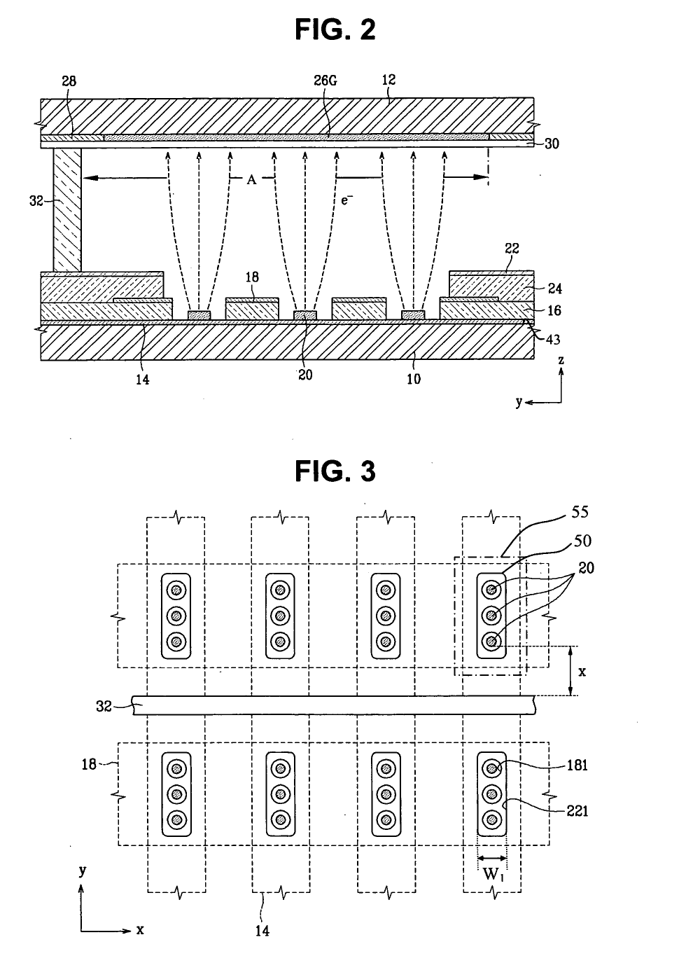

FIGS. 1 and 2 are respectively partial exploded oblique and partial cross-sectional views of an electron emission display constructed as an embodiment of the principles of the present invention.

Referring to FIGS. 1 and 2, electron emission display 1 is constructed with first and second substrates 10 and 12 facing each other in parallel and spaced apart from each other. A sealing member (not shown) is provided at the peripheries of first and second substrates 10 and 12 to seal them together. The interior defined by first and second substrates 10 and 12 and the sealing member is exhausted to form a vacuum envelope kept to a degree of vacuum of about 10⁻⁶ Torr.

A plurality of electron emission elements are arrayed on a surface 43 of first substrate 10 facing second substrate 12. That is, first substrate 10 and the electron emission elements arrayed on first substrate 10 forms an electron emission device. The electron emission device is combined with second substrate 12 on which a light emission unit is provided, thereby forming electron emission display 1.

First, cathode electrodes 14 that are first electrodes are formed in a stripe pattern extending in a direction parallel to first substrate 10 (along the direction of the y-axis in FIG. 1), and a first insulation layer 16 is formed on first substrate 10 to fully cover cathode electrodes 14. Gate electrodes 18 that are second electrodes are formed on the first insulation layer in a stripe pattern running in a direction crossing cathode electrodes 8 at right angles (along the direction of the x-axis in FIG. 1). Both cathode electrodes 14 and gate electrodes are driving electrodes for controlling electron emission by the electron emission regions.

When crossed regions of cathode and gate electrodes 14 and 18 are defined as pixel regions 55, one or more electron emission regions 20 are formed on cathode electrodes 14 at each crossed region. Openings 161 and openings 181 are respectively formed in first insulation layer 16 and gate electrodes 18 to correspond to respective electron emission regions 20, thereby exposing electron emission regions 20 on first substrate 10.

Electron emission regions 20 are made from a material that emits electrons when an electric field is applied thereto under a vacuum atmosphere, such as a carbonaceous material or a nanometer-sized material. For example, electron emission regions 20 can be made from carbon nanotubes, graphite, graphite nanofibers, diamonds, diamond-like carbon, fullerene C₆₀, silicon nanowires, or a combination thereof. Screen printing, direct growth, chemical vapor deposition, or sputtering may be applied to form electron emission regions 20.

Alternatively, electron emission regions 20 may be formed in a Mo-based or a Si-based pointed tip-structure.

In FIGS. 1 and 2, an example where electron emission regions 20 and openings 161 and 181 of first insulating layer 16 and gate electrodes 18, respectively, are circular-shaped and arranged in lines along a length of cathode electrodes 14 is illustrated. The present invention, however, is not limited to this example. That is, the shape and arrangement of electron emission regions 20 and the number of electron emission regions 20 per pixel region may be variously designed.

In addition, in the above description, an example where gate electrodes 18 are disposed above cathode electrodes 14 with first insulation layer 16 interposed between gate electrodes 18 and cathode electrodes 14 is illustrated. The present invention is not limited, however, to this example. That is, gate electrodes 18 may be disposed under cathode electrodes 14 with first insulation layer 16 interposed between gate electrodes 18 and cathode electrodes 14. In this case, electron emission regions 20 may be formed on first insulation layer 16 while contacting side surfaces of cathode electrodes 14.

A focusing electrode 22 that is a third electrode is formed above gate electrodes 18 and first insulation layer 16. A second insulation layer 24 is disposed under focusing electrode 22 to insulate gate electrodes 18 from focusing electrode 22. Openings 221 and openings 241 are respectively formed in focusing electrodes 22 and second insulation layer 24 to allow the electron beams to pass therethrougth. Openings 221 and 241 are provided at each per pixel region 55 so that focusing electrode 22 can generally bias towards convergence the paths of the electrons emitted from the corresponding pixel region 55.

Next, phosphor layers 26 such as red, green and blue phosphor layers 26R, 26G and 26B spaced apart from each other are formed on a surface 41 of second substrate 12 facing first substrate 10. A black layer 28 for enhancing the contrast of the image is formed between phosphor layers 26.

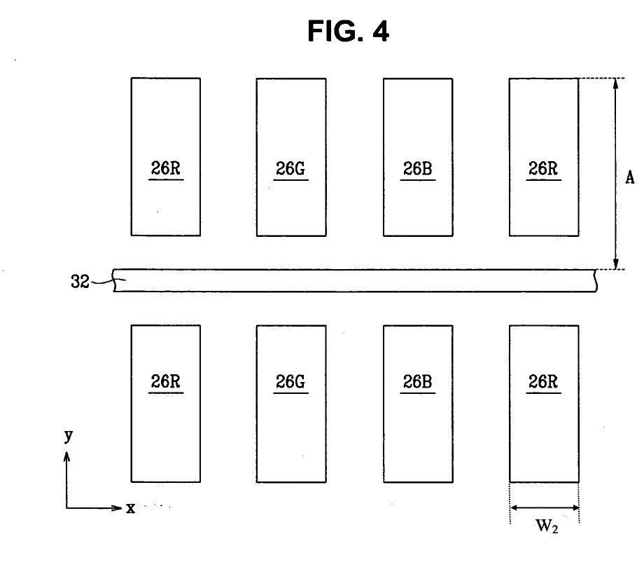

In the present embodiment, red, green and blue phosphor layers 26R, 26G, 26B are formed on the major under surface 41 of second substrate 12 to correspond in spatial alignment with the respective pixel regions 55. Different colors of the phosphor layers are adjacently arranged in a first direction (along the x-axis of FIG. 1) and identical colors of the phosphor layers are adjacently arranged in a second direction (along the y-axis in FIG. 1) crossing the first direction at a right angle. At this point, each of phosphor layers 26R, 26G and 26B may be formed in a longitudinally-lengthy type, as is illustrated by FIG. 4.

An anode electrode 30 may be a metal layer made from, for example, aluminum, and is formed on phosphor and black layers 26 and 28. Anode electrode 30 functions to maintain phosphor layers 26 in a high potential state by receiving a voltage required for accelerating the electron beams and to enhance the screen luminance by reflecting the visible light which is radiated from phosphor layers 26 to first substrate 10 and toward second substrate 12.

Anode electrode 30 may be a transparent and electrically conductive layer made from, for example, indium tin oxide (ITO) other than a metal layer. In this case, anode electrode 30 is formed on surfaces 42 of the phosphor and black layers 26 and 28, that face second substrate 4, and is patterned into a plurality of sections. Alternatively, the transparent conductive layer and the metal layer may be simultaneously formed as anode electrode 30.

Disposed between first and second substrates 10 and 12 are spacers 32 for enduring compression force applied to the vacuum envelope and uniformly maintaining a gap between first and second substrates 10 and 12. Spacers 32 are made from dielectric materials such as glass or ceramic and are placed to correspond to the locations of black layers 28 so as to prevent occurrence of a short circuit between focusing electrode 22 and anode electrode 30 and not to interfere with phosphor layer 26.

In the drawings, a wall-type spacer 32 having a width and height is illustrated. Spacer 32 is not limited, however, to the wall-type as illustrated in FIG. 1 but may be formed in a variety of different shapes. Wall-type spacer 32 may be longitudinally disposed under black layer 28 in a direction along the x-axis of FIG. 1 along which the different colors of phosphor layers 26 are adjacently arranged.

The above-described electron emission display are driven when driving voltages are applied to cathode, gate, focusing, and anode electrodes 14, 18, 22, and 30.

For example, one of cathode and gate electrodes 14 and 18 is applied with a scan driving voltage to function as a scan driving electrode and the other is applied with a data driving voltage to function as a data driving electrode. Focusing electrode 22 is applied with a voltage required for focusing the electron beams, for example, 0 volt or several to tens volts of negative direct current voltage. Anode electrode 30 is applied with a voltage required for accelerating the electron beams, for example, several hundreds through several thousands volts of positive direct current voltage.

Then, electric fields are formed around electron emission regions 20 at pixels where a voltage difference between cathode and gate electrodes 14 and 18 is above a threshold value and thus the electrons are emitted from electron emission regions 20. The emitted electrons converge to a center of a bundle of electron beams while passing through corresponding opening 221 of focusing electrode 22 and collide with corresponding phosphor layer 26 by being attracted by the high voltage applied to anode electrode 30, thereby exciting corresponding phosphor layer 26.

During the operation of electron emission display 1, however, even when focusing electrode 22 applies a repulsive force to the bundle of electron beams to converge the electrons, the electrons' paths, which have passed through opening 221 of focusing electrode 22, are diffused at a diffusing angle while traveling toward second substrate 12. At this point, when some of the diffused electrodes collide with spacer 32, the surface of spacer 32 is charged with an electric potential. An accumulation of there charges causes the electron beam distortion.

When it is assumed that a region on which electron emission regions 20 are placed and which is surrounded by opening 221 of focusing electrode 22 is defined as an effective electron emission region 50 where the electron emission and electron focusing are substantially realized, a location relationship between effective electron emission region 50 and spacer 32 and a location relationship between spacer 32 and the outermost electron emission region 20 closest to spacer 32 are set in electron emission display 1 of the present embodiment as described in the following paragraphs to minimize the collision of the electron beam with spacer 32.

FIG. 3 is a partial top view of a first substrate structure of electron emission display 1 of this embodiment and FIG. 4 is a partial top view of a second substrate structure of electron emission display 1 of this embodiment.

Referring to FIGS. 3 and 4, during the operation of electron emission display 1, since an electron beam spot reaching second substrate 12 is larger than the effective electron emission region due to the diffusion of the electrons emitted from electron emission region 20, each of phosphor layers 26R, 26G and 26B is designed to have a width W₂ greater than the width W₁ of effective electron emission region 50 for the corresponding pixel along the x-axis length of gate electrodes 18. In addition, wall-type spacer 32 is longitudinally arranged along the length of the x-axis of FIG. 4 within a range limited by black layer 28.

Describing the arrangement of the pixel regions adjacent to spacer 32, electron emission display 1 of the present embodiment satisfies the following equation:

[Equation 1]
0.05<x/A≦0.4 (1)
where, “x” is a distance between spacer 32 and the closest edge of the electron emission region 20 which is closest to spacer 32 in a pixel region 55 adjacent to spacer 32, and “A” is a distance between spacer 32 and the end of phosphor layer 26 farthest from spacer 32 in the same pixel region 55.

When the ratio of x/A is 0.05 or less, the electrons emitted from electron emission regions 20 collide with spacer 32 within the electron beam diffusion angle and thus spacer 32 is electrically charged, thereby distorting the electron beam path. When the ratio x/A is greater than 0.4, an area taken by effective electron emission region 50 in one pixel region is too small for electron emission regions 20 to emit electrons that could sufficiently collide with phosphor layers 26, thereby deleteriously reducing the emission efficiency and the screen luminance.

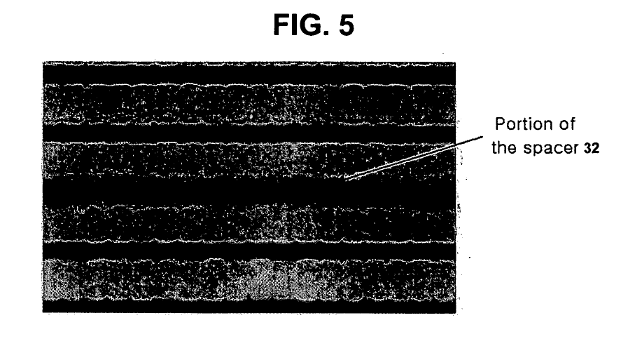

FIG. 5 is a photograph illustrating a comparative example, in which a light emission pattern of the phosphor layers is measured in an electron emission display where the ratio x/A is 0.47. As shown in the photograph of FIG. 5, it is observed that a darkening phenomenon occurs at both sides of the upper and lower portions of the spacer. That is, since the electron beams cannot excite the entire portion of each phosphor layer but partly excite the phosphor layer, the light emission uniformity of the phosphor layer is deleteriously reduced and the lack of uniformity can be noted by the darkening along the spacer mounting portion as is shown on the screen.

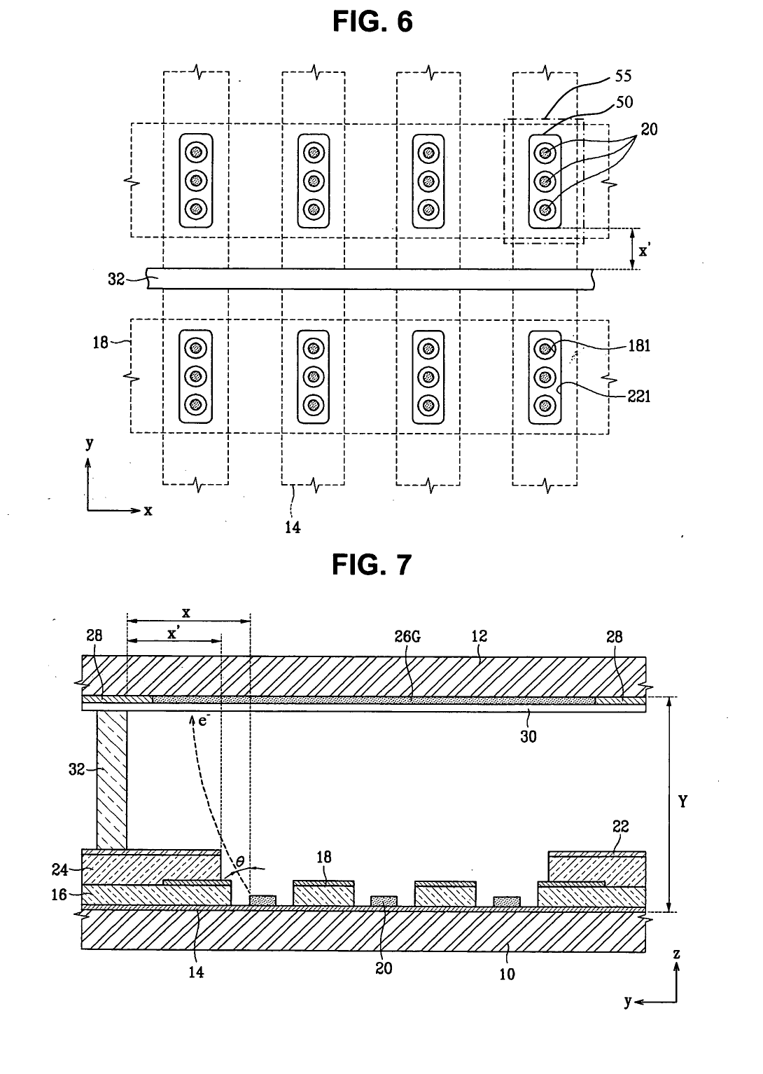

At this point, since a distance between the outermost electron emission region 20 and an end of the effective electron emission region is extremely small, in Equation 1, the distance “x” between spacer 32 and the closest part of the closest electron emission region 20 to spacer 32 may be, as shown in FIG. 6, replaced with a distance “x” between the closest part of effective electron emission region to spacer 32, and spacer 32.

As described above, as electron emission display 1 of the present embodiment satisfies Equation 1, the electron beam collision with spacer 32 is minimized and thus the electric charging of spacer 32 and the electron beam distortion can be suppressed. Furthermore, since the sufficient large effective electron emission region can be obtained in one pixel region, the emission efficiency and the screen luminance can be improved.

Meanwhile, as shown in FIG. 7, in the pixel region 55 adjacent to spacer 32, electron emission display 1 of the present embodiment satisfies the following equation 2:

[Equation 2]
x>Y•tan θ(θ<10°) (2)
where, “x” is a distance between spacer 32 and the closest part of electron emission region 20 to spacer 32 in the pixel region adjacent to spacer 32, “θ” is an electron beam diffusion angle, and “Y” is a distance between first and second substrates 10 and 12.

When the “x” is greater than “Y.tan θ”, the electrons collide with an upper region of the spacer 32 to charge spacer 32 and thus the electron beam distortion occurs. That is, Equation 2 means that when the electron beam diffusion angle is less than 10°, spacer 32 can be located at a place where no electron beam collides with spacer 32. Therefore, the charging of spacer 32 can be effectively suppressed.

Turning now to FIG. 6, and as described above, since a distance between the outermost electron emission region 20 and an end of the effective electron emission region is extremely small, in Equation 2, the distance “x” between spacer 32 and the outermost electron emission region 20 closest to spacer 32 may be, replaced with a distance “x′” between the effective electron emission region and spacer 32.

In the above description, although the FEA type electron emission display having electron emission materials that can emit electrons by electric fields under a vacuum atmosphere is illustrated, the present invention is not limited to the FEA type electron emission display. That is, the present invention can be applied to a variety of other types of electron emission displays each having the electron emission regions, the phosphor layers and the spacers.

As described in the foregoing paragraphs, since electron emission display 1 of the present invention is designed to minimize the collision of the electrons with the spacers, the electron beam distortion caused by the charging of the spacers can be suppressed. Therefore, electron emission display 1 of the present invention can accurately reproduce the color around the spacers and prevent the spacer from being shown on the screen, thereby preventing deterioration of the display quality.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. An electron emission display, comprising:
first and second substrates facing each other and having pixel regions;
electron emission regions formed on the first substrate;
driving electrodes provided on the first substrate to control an electron emission of the electron emission regions;
phosphor layers formed on a surface of the second substrate and spaced apart from each other;
an anode electrode formed on a surface of the phosphor layer; and
spacers disposed between the first and second substrates aligned in correspondence with a region between the phosphor layers, with the electron emission display satisfying the following condition:
0.05<x/A≦0.4
where “x” is a distance between the spacer and the closest part of the electron emission region which is closest to the spacer in at least one pixel region adjacent to the spacer, and “A” is a distance between the spacer and the farthest end of the phosphor layer from the spacer in the pixel region adjacent to the spacer.

2. The electron emission display of claim 1, comprised of the driving electrodes comprising:
cathode electrodes electrically connected to the electron emission regions; and
gate electrodes insulated from the cathode electrodes.

3. The electron emission display of claim 1, comprised of the electron emission regions being made from a carbon-based material or a nanometer sized material.

4. The electron emission display of claim 1, further comprising a focusing electrode disposed above the driving electrodes and insulated from the driving electrodes.

5. The electron emission display of claim 4, comprised of the focusing electrode being provided with an opening surrounding the electron emission regions at each pixel region and the effective electron emission region corresponds to the opening of the focusing electrode.

6. The electron emission display of claim 1, comprised of the spacers being wall-type spacers and arranged in parallel with one of the driving electrodes.

7. An electron emission display, comprising:
first and second substrates facing each other and having pixel regions;
electron emission regions formed on the first substrate;
driving electrodes provided on the first substrate to control an electron emission of the electron emission regions;
phosphor layers formed on a surface of the second substrate and spaced apart from each other;
an anode electrode formed on a surface of the phosphor layer; and
spacers disposed between the first and second substrates aligned in correspondence with a region defined between the phosphor layers,
with, when a portion of the pixel region, at which the electron emission regions are provided to substantially emit electrons, is defined as an effective electron emission region, the electron emission display satisfying the following condition:
0.05<x′/A≦0.4
where “x′” is a distance between the spacer and the effective electron emission region in at least one pixel region adjacent to the spacer and “A” is a distance between the spacer and the farthest end of the phosphor layer from the spacer in the pixel region adjacent to the spacer.

8. The electron emission display of claim 7, comprised of the driving electrodes comprising:
cathode electrodes electrically connected to the electron emission regions; and
gate electrodes insulated from the cathode electrodes.

9. The electron emission display of claim 7, comprised of the electron emission regions being made from a carbon-based material or a nanometer sized material.

10. The electron emission display of claim 7, further comprising a focusing electrode disposed above the driving electrodes and insulated from the driving electrodes.

11. The electron emission display of claim 10, comprised of the focusing electrode being provided with an opening surrounding the electron emission regions at each pixel region and the effective electron emission region corresponds to the opening of the focusing electrode.

12. The electron emission display of claim 7, comprised of the spacers being wall-type spacers and arranged in parallel with one of the driving electrodes.

13. An electron emission display, comprising:
first and second substrates facing each other and having pixel regions;
electron emission regions formed on the first substrate;
driving electrodes provided on the first substrate to control an electron emission of the electron emission regions;
phosphor layers formed on a surface of the second substrate and spaced apart from each other;
an anode electrode formed on a surface of the phosphor layer; and
spacers disposed between the first and second substrates aligned in correspondence with a region defined between the phosphor layers, with the electron emission display satisfying the following condition:
x>Y•tan θ(where θ<10°)
where “x” is a distance between the spacer and the closest part of the electron emission region that is closest to the spacer in the pixel region adjacent to the spacer, “θ” is an electron beam diffusion angle, and “Y” is a distance between the first and second substrates.

14. The electron emission display of claim 13, comprised of the driving electrodes comprising:
cathode electrodes electrically connected to the electron emission regions; and
gate electrodes insulated from the cathode electrodes.

15. The electron emission display of claim 13, comprised of the electron emission regions being made from a carbon-based material or a nanometer sized material.

16. The electron emission display of claim 13, further comprising a focusing electrode disposed above the driving electrodes and insulated from the driving electrodes.

17. The electron emission display of claim 16, comprised of the focusing electrode being provided with an opening surrounding the electron emission regions at each pixel region and the effective electron emission region corresponds to the opening of the focusing electrode.

18. The electron emission display of claim 13, wherein the spacers are wall-type spacers and are arranged in parallel with one of the driving electrodes.

19. An electron emission display, comprising:
first and second substrates facing each other and having pixel regions;
electron emission regions formed on the first substrate;
driving electrodes provided on the first substrate to control an electron emission of the electron emission regions;
phosphor layers formed on a surface of the second substrate and spaced apart from each other;
an anode electrode formed on a surface of the phosphor layer; and
spacers disposed between the first and second substrates aligned in correspondence with a region defined between the phosphor layers, with, when a portion of the pixel region, at which the electron emission regions are provided to substantially emit electrons, is defined as an effective electron emission region, the electron emission display satisfying the following condition:
x′>Y•tan θ(where θ<10°)
where “x′” is a distance between the spacer and the effective electron emission region in at least one pixel region adjacent to the spacer, “θ” is an electron beam diffusion angle and θ is less than 10°, and “Y” is a distance between the first and second substrates.

20. The electron emission display of claim 19, comprised of the driving electrodes comprising:
cathode electrodes electrically connected to the electron emission regions; and
gate electrodes insulated from the cathode electrodes.

21. The electron emission display of claim 19, comprised of the electron emission regions being made from a carbon-based material or a nanometer sized material.

22. The electron emission display of claim 19, further comprising a focusing electrode disposed above the driving electrodes and insulated from the driving electrodes.

23. The electron emission display of claim 22, comprised of the focusing electrode being provided with an opening surrounding the electron emission regions at each pixel region and the effective electron emission region corresponds to the opening of the focusing electrode.

24. The electron emission display of claim 19, comprised of the spacer being a wall-type and arranged in parallel with one of the driving electrodes.
